(19) United States
(12) Patent Application Publication
(10) Pub. No.: US 2014/0130494 A1
(43) Pub. Date: May 15, 2014

(54) AIR COMPRESSING DEVICE OF ENGINE

(71) Applicant: HKS CO., LTD., Shizuoka (JP)

(72) Inventors: Hiroyuki HASEGAWA, Shizuoka (JP); Kinpei ASAZUMA, Shizuoka (JP)

(21) Appl. No.: 14/066,927

(22) Filed: Oct. 30, 2013

(30) Foreign Application Priority Data
Nov. 13, 2012 (JP) 2012-249729

(51) Int. Cl. F02M 25/07

(52) U.S. Cl. CPC F02M 25/0707
USPC 60/605.2

(57) ABSTRACT

In a air compressing device of an engine, a supercharger interposed in an EGR pipe diverging from a portion of an exhaust pipe of the engine on the downstream side of a turbine of a turbocharger, pressurizing an EGR gas introduced into an EGR pipe by a compressor driven by rotation of the engine and supplying the pressurized EGR gas to an intake manifold of the engine, and control structure for adjusting an opening of a throttle valve arranged in a portion of the EGR pipe on the downstream side of the compressor of the supercharger and controlling a supply amount of the EGR gas supplied from the compressor to the intake manifold.

### BACKGROUND OF THE INVENTION

1. Field of the Invention

The present invention relates to a supercharging or turbocharging device of an engine suitable for use in a diesel engine and others.

2. Description of the Related Art

Conventionally, such an EGR (Exhaust Gas Recirculation) system of a diesel engine has been proposed that returns an exhaust gas diverging from an exhaust pipe of the engine to an intake manifold, and thereby lowers a combustion temperature to reduce NOx.

In an air compressing device of an engine disclosed in JP 2007-77854 A (Patent Literature 1), a turbocharger and an EGR pipe are arranged in an exhaust pipe of the engine. The turbocharger has a turbine rotated by an exhaust gas discharged through the exhaust pipe of the engine, and supplies an air compressed by a compressor to an intake manifold. The EGR pipe diverges at a portion on the upstream side of the turbine of the turbocharger in the exhaust pipe of the engine, and introduces a part of the exhaust gas of the engine to the intake manifold as an EGR (Exhaust Gas Recirculation) gas. An EGR cooler for cooling the EGR gas and an EGR valve are interposed in the EGR pipe.

The supercharging device of the engine disclosed in Patent Literature 1 has the following problems.

(1) A part of the exhaust gas of the engine is introduced as the EGR gas into the EGR pipe through a portion on the upstream side of the turbine of the turbocharger, and is not used for rotating the turbine. This impairs the work of the turbocharger. Since the EGR gas introduced into the EGR pipe is not used for rotating the turbine, it is not cooled by such use, which causes a large load on the EGR cooler.

(2) The EGR gas is not particularly pressurized, and is merely introduced into the intake manifold through the EGR pipe. Therefore, the EGR gas may not reach the intake manifold or may flow reversely because its pressure is lower than the pressure of the air that is supplied to the intake manifold after being pressurized by the compressor of the turbocharger. For avoiding the unreached flow to the intake manifold or the reverse flow of the EGR gas, a variable nozzle vane mechanism is arranged at an inlet of the turbine of the turbocharger for increasing the exhaust pressure, and supplying the pressurized EGR gas to the intake manifold through the EGR pipe. This complicates the turbocharger and increases its cost.

### SUMMARY OF THE INVENTION

An object of the invention is to effectively use an exhaust gas of an engine provided with a turbocharger and employing an EGR system, thereby to reduce a load on an EGR cooler and to stably supply an EGR gas to an intake manifold without impairing a work of the turbocharger.

In accordance with the present invention, there is provided an air compressing device of an engine comprising a turbocharger having a turbine rotated by an exhaust gas discharged to an exhaust pipe of the engine, and supplying an air compressed by a compressor to an intake manifold of the engine; a supercharger interposed in an EGR pipe diverging from a portion of the exhaust pipe of the engine downstream from the turbine of the turbocharger, and configured to compress an EGR gas introduced into the EGR pipe by the compressor driven by the rotation of the engine and to supply the pressurized EGR gas to the intake manifold of the engine; and control structure for adjusting an opening of a throttle valve arranged in a portion of the EGR pipe downstream from the compressor of the supercharger, and controlling a supply amount of the EGR gas supplied from the compressor to the intake manifold.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 schematically illustrates an air compressing device of an engine; and

FIG. 2 is a characteristic diagram of superchargers of a centrifugal compressor type and a volume compressor type.

### DESCRIPTION OF THE PREFERRED EMBODIMENTS

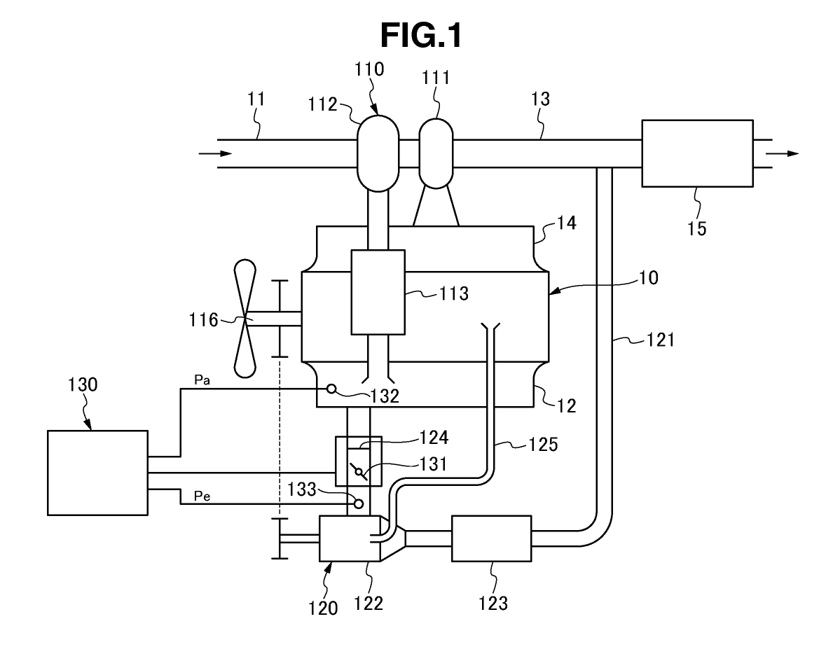

FIG. 1 illustrates an embodiment of an air compressing device 100 for a diesel engine 10 of an automobile according to the invention. The engine 10 has an intake manifold 12 connected to an intake pipe 11 and an exhaust manifold 14 connected to an exhaust pipe 13. An exhaust processing device 15 is interposed on an output side of the exhaust manifold 14.

The air compressing device 100 has a turbocharger 110, a supercharger 120 and control structure (engine CPU) 130.

The turbocharger 110 has a turbine 111 rotated by an exhaust gas discharged to the exhaust pipe 13 of the engine 10, and supplies a combustion air pressurized by a compressor 112 interposed in the intake pipe 11 to the intake manifold 12 of the engine 10 through an intercooler 113.

The supercharger 120 is interposed in an EGR pipe 121 diverging from a portion on the downstream side of the turbine 111 of the turbocharger 110 of the exhaust pipe 13 of the engine 10. The supercharger 120 is coupled to a rotation shaft 16 of the engine 10 via a belt, compresses the EGR gas (recirculation gas) introduced into the EGR pipe 121 by a compressor 122 driven by the rotation of the engine 10 and supplies the pressurized EGR gas to the intake manifold 12 of the engine 10.

The control structure 130 adjusts an opening of a throttle valve 131 arranged on a portion on the downstream side of the compressor 122 (i.e. near the intake manifold 12) of the supercharger 120 in the EGR pipe 121, and thereby controls an amount of the EGR gas supplied to the intake manifold 12 from the compressor 122. The control structure 130 is configured to adjust the opening of the throttle valve 131 to supply the EGR gas pressurized by the compressor 122 of the supercharger 120 to the intake manifold 12 of the engine 10 without reversely flowing it, based on input information such as a pressure Pa of the air supplied from the compressor 112 of the turbocharger 110 through the intercooler 113 to the intake manifold 12, a discharge pressure Pe of the compressor 122 of the supercharger 120, a rotation speed of the engine 10 and a fuel supply amount of the engine 10. In FIGS. 1, 132 and 133 indicate pressure sensors for detecting Pa and Pe, respectively.

The air compressing device 100 has an EGR cooler 123 interposed in a position on the upstream side of the compressor 122 of the supercharger 120 in the EGR pipe 121.

A check valve 124 for preventing reverse flow from the intake manifold 12 toward the compressor 122 is arranged in a portion of the EGR pipe 121 downstream from the compressor 122 of the supercharger 120. In this embodiment, the check valve 124 is located to the intake manifold 12 side of the throttle valve 131.

The compressor 122 of the supercharger 120 can receive a blowby gas through a breather hose 125 connected to the engine 10.

The air compressing device 100 achieves the following operation and effect.

(a) The exhaust gas is supplied as the EGR gas to the EGR pipe 121 though a portion downstream from the turbine 111 of the turbocharger 110 after it is used for rotation of the turbine 111. Therefore, it does not impair the work of the turbocharger 110.

The EGR gas supplied to the EGR pipe 121 has a low temperature because it is already used for the work of the turbocharger 110. This reduces the load on the EGR cooler 123.

(b) The supercharger 120 pressurizes the EGR gas before it is supplied to the intake manifold 12. Therefore, the EGR gas is in the pressurized state with respect to the pressure of the air which is supplied to the intake manifold 12 after having been pressurized by the turbocharger 110, and is stably supplied to the intake manifold 12 without reverse flow away from the intake manifold 12.

The throttle valve 131 of which opening is controlled by the control structure 130 controls the flow amount of the EGR gas with respect to the flow amount of the air supplied by the turbocharger 110, and it optimizes the EGR rate ((EGR gas flow amount)/(air flow amount+EGR gas flow amount)) with respect to the change in load or rotation speed of the engine 10, and can reduce the discharge amount of the NOx.

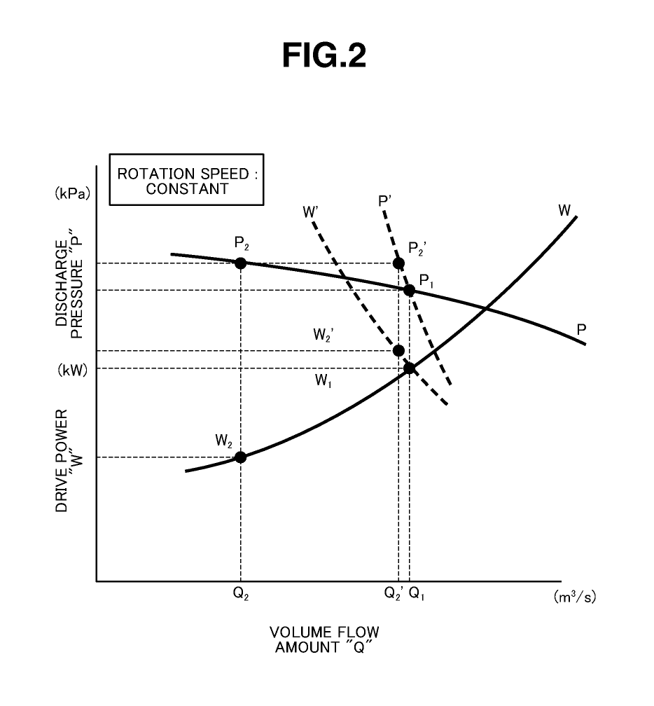

The supercharger 120 can be either of a centrifugal compressor type or a volume compressor type. FIG. 2 illustrates, as a characteristic diagram, the changes that occur in the discharge pressure P of the compressor 122 and a drive power W with respect to the changes in the discharge flow amount (volume flow rate) Q in the used flow amount range (Q1˜Q2) of the EGR gas controlled by the throttle valve 131 after being discharged from the compressor 122 of the supercharger 120 rotating at a certain constant speed. In FIG. 2, solid lines (P and W) represent the characteristics of the supercharger of the centrifugal compressor type, and broken lines (P′ and W′) represent the characteristics of the supercharger of the volume compressor type. Therefore, when the supercharger of the centrifugal compressor type is used as the supercharger 120, it achieves the following operations and effects (c) and (d).

(c) When the throttle valve 131 for the supercharger 120 of the centrifugal compressor type controls the discharge flow amount (volume flow rate Q) in the used flow amount range (Q1˜Q2) of the EGR gas discharged from the compressor 122 of the supercharger 120 with respect to the flow amount of the air supplied by the turbocharger 110, the change (P1˜P2) of the discharge pressure (P) of the supercharger 120 is small (P1 and P2 correspond to Q1 and Q2, respectively). Therefore, the pressure of the EGR gas in the used flow amount range hardly lowers with respect to the pressure of the air supplied to the intake manifold after being pressurized by the turbocharger 110. Therefore, there is no possibility of reverse flow away from the intake manifold.

When the throttle valve 131 for the supercharger 120 of the volume compressor type controls the discharge flow amount in the used flow amount range of the EGR gas discharged from the compressor 122 of the supercharger 120, the discharge pressure of the compressor 122 changes to a large extent, and reverse flow away from the intake manifold may occur.

(d) When the throttle valve 131 for the supercharger 120 of the centrifugal compressor type controls the discharge flow amount (volume flow rate Q) in the used flow amount range (Q1˜Q2) of the EGR gas discharged from the compressor 122 of the supercharger 120 for optimizing the EGR rate with respect to the flow amount of the air supplied by the turbocharger 110, the drive power (W1˜W2) is small and falls in a range not exceeding a predetermined value (W1) (W1 and W2 correspond to Q1 and Q2, respectively).

When the throttle valve 131 for the supercharger 120 of the volume compressor type controls the discharge flow amount (volume flow rate Q) in the used flow amount range (Q1˜Q2) of the EGR gas discharged from the compressor 122 of the supercharger 120, the drive power (W1˜W2) significantly increases in a range of the predetermined value (W1) or more.

Employment of the supercharger 120 of the centrifugal compressor type can reduce the occupied space in an engine room of a vehicle, because it is more compact in size than the supercharger of the volume compressor type.

The disclosure of the present invention is as follows.

An air compressing device of an engine comprising

a turbocharger having a turbine rotated by an exhaust gas discharged to an exhaust pipe of the engine, and supplying an air compressed by a compressor to an intake manifold of the engine.

A supercharger is interposed in an EGR pipe diverging from a portion of the exhaust pipe of the engine downstream from the turbine of the turbocharger, and is configured to compress an EGR gas introduced into the EGR pipe by the compressor driven by the rotation of the engine and to supply the pressurized EGR gas to the intake manifold of the engine.

Control structure is set out for adjusting an opening of a throttle valve arranged in a portion of the EGR pipe downstream from the compressor of the supercharger, and for controlling a supply amount of the EGR gas supplied from the compressor to the intake manifold.

A further embodiment of the air compressing device of the engine discloses

the supercharger is of a centrifugal compressor type.

A further embodiment of the air compressing device of the engine discloses

an EGR cooler is interposed in a portion of the EGR pipe on the upstream side of the compressor of the supercharger.

A further embodiment of the air compressing device of the engine discloses

a check valve for checking reverse flow from the intake manifold is arranged in a portion of the EGR pipe on the downstream side of the compressor of the supercharger.

A further embodiment of the air compressing device of the engine discloses

the control structure is configured to adjust the opening of the throttle valve to supply the EGR gas pressurized by the compressor of the supercharger to the intake manifold of the engine without reversely flowing it, based on input information such as a pressure Pa of the air supplied from the compressor of the turbocharger through the intercooler to the intake manifold, a discharge pressure Pe of the compressor of the supercharger.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention. For example, the invention is not restricted to a diesel engine, and may be used in a gasoline engine, a CNG (compressed natural gas) engine and others.

In accordance with the present invention, there is provided an air compressing device of an engine comprising a turbocharger having a turbine rotated by an exhaust gas discharged to an exhaust pipe of the engine, and supplying an air compressed by a compressor to an intake manifold of the engine. A supercharger is interposed in an EGR pipe diverging from a portion of the exhaust pipe of the engine downstream from the turbine of the turbocharger, and is configured to compress an EGR gas introduced into the EGR pipe by the compressor driven by the rotation of the engine and to supply the pressurized EGR gas to the intake manifold of the engine. Control structure is set out for adjusting an opening of a throttle valve arranged in a portion of the EGR pipe downstream from the compressor of the supercharger, and for controlling a supply amount of the EGR gas supplied from the compressor to the intake manifold. Accordingly, it is possible to effectively use exhaust gas of an engine provided with a turbocharger and employing an EGR system, thereby to reduce a load on an EGR cooler and to stably supply EGR gas to an intake manifold without impairing a work of the turbocharger.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. An air compressing device of an engine comprising:
a turbocharger having a turbine rotated by an exhaust gas discharged to an exhaust pipe of the engine, and supplying air compressed by a compressor to an intake manifold of the engine;
a supercharger interposed in an EGR pipe diverging from a portion of the exhaust pipe of the engine downstream from the turbine of the turbocharger, and configured to compress EGR gas introduced into the EGR pipe by the compressor driven by the rotation of the engine and to supply the pressurized EGR gas to the intake manifold of the engine; and
control structure for adjusting an opening of a throttle valve arranged in a portion of the EGR pipe downstream from the compressor of the supercharger, and controlling a supply amount of the EGR gas supplied from the compressor to the intake manifold.

2. The air compressing device of the engine according to claim 1, wherein
the supercharger is a centrifugal compressor type.

3. The air compressing device of the engine according to claim 1, wherein
an EGR cooler is interposed in a portion of the EGR pipe on the upstream side of the compressor of the supercharger.

4. The air compressing device of the engine according to claim 1, wherein
a check valve for checking reverse flow from the intake manifold is arranged in a portion of the EGR pipe on the downstream side of the compressor of the supercharger.

5. The air compressing device of the engine according to claim 1, wherein
the control structure is configured to adjust the opening of the throttle valve to supply the EGR gas pressurized by the compressor of the supercharger to the intake manifold of the engine without reversely flowing it, based on input information such as a pressure Pa of the air supplied from the compressor of the turbocharger through the intercooler to the intake manifold, and a discharge pressure Pe of the compressor of the supercharger.

6. The air compressing device of the engine according to claim 2, wherein
an EGR cooler is interposed in a portion of the EGR pipe on the upstream side of the compressor of the supercharger.

7. The air compressing device of the engine according to claim 2, wherein
a check valve for checking reverse flow from the intake manifold is arranged in a portion of the EGR pipe on the downstream side of the compressor of the supercharger.

8. The air compressing device of the engine according to claim 3, wherein
a check valve for checking reverse flow from the intake manifold is arranged in a portion of the EGR pipe on the downstream side of the compressor of the supercharger.

9. The air compressing device of the engine according to claim 2, wherein
the control structure is configured to adjust the opening of the throttle valve to supply the EGR gas pressurized by the compressor of the supercharger to the intake manifold of the engine without reversely flowing it, based on input information such as a pressure Pa of the air supplied from the compressor of the turbocharger through the intercooler to the intake manifold, and a discharge pressure Pe of the compressor of the supercharger.

10. The air compressing device of the engine according to claim 3, wherein
the control structure is configured to adjust the opening of the throttle valve to supply the EGR gas pressurized by the compressor of the supercharger to the intake manifold of the engine without reversely flowing it, based on input information such as a pressure Pa of the air supplied from the compressor of the turbocharger through the intercooler to the intake manifold, and a discharge pressure Pe of the compressor of the supercharger.

11. The air compressing device of the engine according to claim 4, wherein
the control structure is configured to adjust the opening of the throttle valve to supply the EGR gas pressurized by the compressor of the supercharger to the intake manifold of the engine without reversely flowing it, based on input information such as a pressure Pa of the air supplied from the compressor of the turbocharger through the intercooler to the intake manifold, and a discharge pressure Pe of the compressor of the supercharger.
